(19) United States
(12) Patent Application Publication
(10) Pub. No.: US 2008/0083699 A1
(43) Pub. Date: Apr. 10, 2008

(54) Method of producing a reflecting surface inside a substrate

(76) Inventors: David Brooks, Hod Hasharon (IL); Serge Steinblatt, Ra'anana (IL); David Lachmann, Mevasseret Zion (IL)

Correspondence Address: Pearl Cohen Zedek Latzer, LLP, 1500 Broadway, 12th Floor, New York, NY, 10036, US

(21) Appl. No.: 11/544,619

(22) Filed: Oct. 10, 2006

(51) Int. Cl. B29D 11/00; B23P 15/00

(52) U.S. Cl. 216/24; 216/60; 216/65; 216/39

(57) ABSTRACT

The present invention provides a system and method for producing a groove with a required shape in a substrate, wherein the groove has at least one facet for folding a beam of light. The system includes a drilling laser beam for producing the groove, the laser beam passable through an aperture to affect the shape of the groove, wherein at least one facet of said groove intersects a path of the beam of light.

### BACKGROUND OF THE INVENTION

There are various known methods to fold a beam of light, advancing in a waveguide, towards the surface of the substrate of the waveguide.

Some of the known methods use gratings on the surface of the waveguide to fold the beam of light.

Reference is now made to FIG. 1, which is a known method to fold a beam of light towards the surface of the substrate 4. An edge 2 of a substrate 4 is cut and polished to form an inclined edge 6, inclined in an angle of 45°, acting substantially as a mirror reflecting the beam of light advancing in substrate 4. A device 8 to receive the folded beam of light is mounted substantially above inclined edge 6 of the substrate. Substrate 4 is usually very thin relative to the size of device 8 and therefore the length of inclined edge 6 is usually smaller than the length of device 8. Due to the size of device 8, part of it usually protrudes out of substrate 4. Therefore, the installation of device 8 on substrate 4 is not stable. Additionally, in case that device 8 needs covering to insulate it from the environment, it is hard to assemble a cover when device 8 is positioned above inclined edge 6.

### SUMMARY OF THE INVENTION

According to some embodiments of the invention, a system may be provided for producing a groove in a substrate, for example, with a required shape. The groove may enable folding of a beam of light. For example, a facet of the groove may intersect the path of said beam of light, thus, for example, folding the beam of light. The beam of light may advance, for example, in a buried waveguide. The system may comprise a mask, for example, with an aperture, for example, with the required shape. When passing a drilling laser beam through the aperture, an image of said aperture may be provided, for example, on said substrate. Incidence of the beam of light on said substrate may cause production of a groove, for example, having an opening cross section with the shape of a projection of said image on the substrate. The drilling laser beam may be tuned, for example, for creating a predetermined angle of incidence of the beam of light with the facet. In some embodiments, the system may include a lens. Passing of the drilling laser beam through said lens may affect, for example, the size of the projection of said image on the substrate.

The system may further include, according to some embodiments of the present invention, a shutter. Movement of the shutter, for example, to change the shape of the aperture, for example, during exposure of the aperture to the drilling laser beam, may provide varied depth to the groove, thus, for example, providing a required three dimensional shape, for example a curved mirror, to the facet of the groove which may intersect the path of the beam of light. The facet may be coated with a reflective coating in order to ensure total reflection of the beam of light.

According to some embodiments of the invention, a method for folding a beam of light may comprise the step of producing by a drilling laser beam at least one groove in a substrate, the groove may enable folding of a beam of light. The beam of light may advance, for example, in a waveguide. For example, a facet of the groove may intersect the path of said beam of light, thus, for example, folding the beam of light. The folding may be, for example, towards a device mounted on a surface of the substrate and/or into a waveguide. The method may further include the step of setting a predetermined angle of incidence of the beam of light with the facet, for example, by tuning the direction of said drilling laser beam, for example, in order to fold the beam of light perpendicularly to the surface of the substrate. The method may include providing the facet with a total internal reflection by, for example, coating at least a portion of the facet with a reflective coating.

The method may further include, according to some embodiments of the present invention, the step of providing varied depth to said groove, thus, for example, providing a required shape to the facet of the groove which may intersect the path of the beam of light. For example, the method may include moving of the shutter, for example, to change the shape of the aperture, for example, during exposure of the aperture to the drilling laser beam. By providing varied depth, the facet may act as a concentrator mirror, for example, when a facet with concave shape is provided. The facet may act as a dispersing mirror, for example, when a facet with convex shape is provided.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a known method to fold a beam of light towards the surface of the substrate of the waveguide.

FIG. 2 is an illustration of a system comprising means to fold a beam of light according to some embodiment of the present invention.

FIG. 3 is a schematic illustration of a system allowing production by laser of a groove in a desired shape, according to some embodiments of the present invention.

FIG. 4 is a schematic cross section illustration of a system including a groove according to some embodiments of the present invention.

FIG. 5 is a cross section illustration of a system, demonstrating tuning of the direction of a drilling laser beam according to inclination angle of facet according to some embodiments of the present invention.

FIG. 6 is a cross section illustration of a system, demonstrating angle of implementation of a coating according to some embodiments of the present invention.

FIG. 7 is a flowchart describing a method for folding a beam of light according to some embodiments of the present invention.

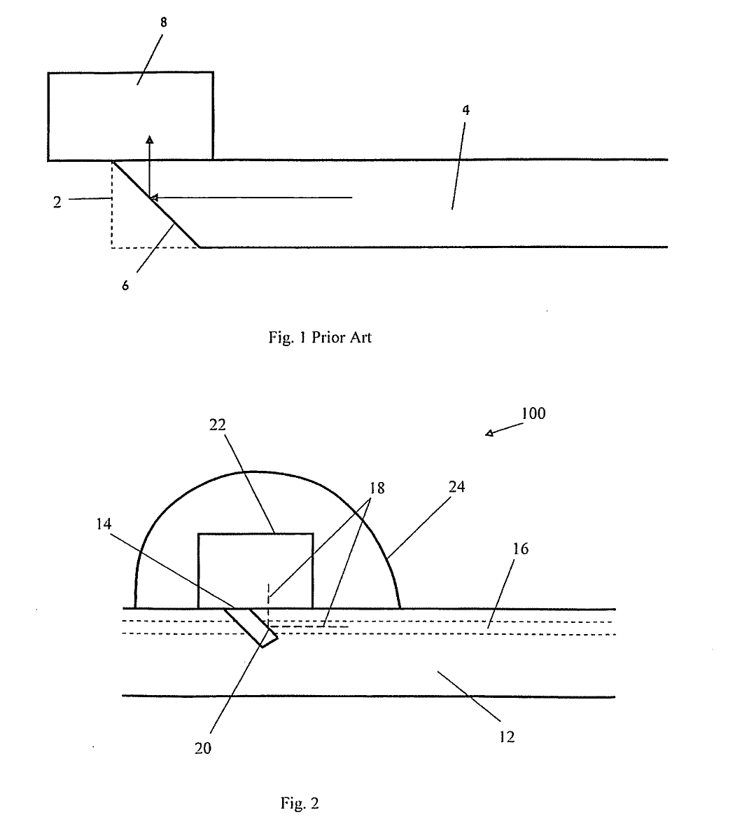

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Reference is made to FIG. 2 which is an illustration of system 100 comprising means to fold a beam of light according to some embodiments of the present invention. A substrate 12 may include a waveguide 16. A groove 14 may be produced in substrate 12, for example by laser. Groove 14 may intersect buried waveguide 16. A beam of light 18 may be reflected on a facet 20 of groove 14. In one embodiment, the reflection may fold beam of light 18, for example, advancing in waveguide 16, for example, towards the surface of substrate 12, typically into an optical device 22. In another embodiment, the reflection may fold beam of light 18, for example, emerging from optical device 22, for example, into waveguide 16. Groove 14 may be produced with total internal reflection and/or reflective coating, for example, on facet 20, thus enabling reflection of beam of light 18. The reflective coating may include, for example, aluminum, gold or other low loss metals or dielectric materials. Groove 14 may be produced in any shape, for example, according to specific requirements on the angle of reflection and/or dispersing/concentrating of beam of light 18. Groove 14, for example, may enable folding of beam of light 18 perpendicularly to the direction of propagating in waveguide 16, by, for example, being produced with inclination of 45° relative to the direction of propagating in buried waveguide 16. Groove 14, for example, may be produced with a concave or convex shape, in order to concentrate or disperse beam of light 18, respectively. Groove 14 may be produced in any location along waveguide 16, for example, in a location allowing sufficient area on the surface of substrate 12 for a stable installation of device 22. The sufficient area may enable, in some embodiments, insulation from the environment of device 22, for example, by a cover 24, for example, also installed on the surface of substrate 12.

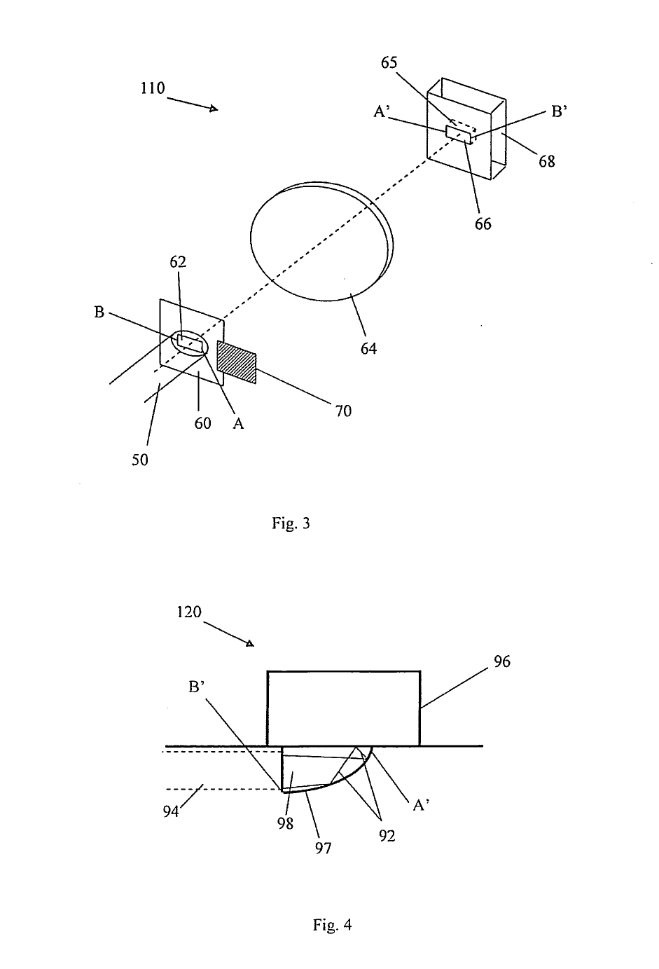

Reference is made to FIG. 3, which is a schematic illustration of a system 110 allowing production by laser of a groove in a desired shape, according to some embodiments of the present invention. Drilling laser beam 50 may produce a groove 65 in a substrate 68, for example, in order to provide a reflecting surface for reflection of a beam of light advancing in substrate 68, for example, as described above with reference to FIG. 2. The shape of groove 65 may be affected by the angle of incidence of drilling laser beam 50 at substrate 68 and/or by the intensity of the energy applied by drilling laser beam 50. Drilling laser beam 50 may pass through an aperture 62 in a mask 60. For illustration only, the shape of aperture 62 shown in FIG. 3 is rectangular, although the invention is not limited in this respect and aperture 62 may practically have any desired shape. The size of aperture 62 may be smaller than the diameter of drilling laser beam 50, for example, in order that the light passes through mask 60 may create an image 66 with the shape of aperture 62, for example, on substrate 68. The energy applied by drilling laser beam 50 on the area defined by the projection of image 66 on substrate 68 may cause production of groove 65 in substrate 68, for example, with an opening cross section shape of image 66. The depth of groove 65 may depend on the intensity of drilling laser beam 50 and the duration of applying of the energy by drilling laser beam 50, e.g., the duration of exposure of substrate 68 to drilling laser beam 50. Mask 60 may be positioned to place aperture 62 in a zone of the beam that is substantially homogeneous, for example, in order that the energy applied on the area defined by the projection of image 66 on substrate 68 may be spread in a substantially homogeneous manner. An imaging lens 64 may be placed in the path of drilling laser beam 50 between mask 60 and substrate 68. Lens 64 may be used to adjust the size of image 66, thus, for example, adjusting the size of groove 65. For example, Lens 64 may be a concentrator lens and/or may reduce the size of the projection of image 66 on substrate 68. System 110 may further include a shutter 70. By changing the size of aperture 62, for example, while exposure of aperture 62 to drilling laser beam 50, groove 65 may be produced with varied depth. The size of aperture 62 may be changed, for example, by moving shutter 70 from side A of aperture 62 toward side B of aperture 62 and thus, for example, side A′ of groove 65 may be exposed to drilling laser beam 50 for shorter time then side B′ of groove 65. Shorter exposure of side A′ to beam light 50 may, for example, cause side A′ to be shallower than side B′. Moving shutter 70 in a constant velocity may provide, for example, a constant slope in the bottom of groove 65. Moving shutter 70 in a varied velocity may provide, for example, a varied slope in the bottom of groove 65. Moving shutter 70 in an increasing velocity may provide, for example, a concave shape in the bottom of groove 65. Moving shutter 70 in a decreasing velocity may provide, for example, a convex shape in the bottom of groove 65.

Reference is made to FIG. 4, which is a schematic cross section illustration of a system 120 including a groove 98 according to some embodiments of the present invention. A concave facet 97 of groove 98 may be provided, for example, as described above with reference to FIG. 3. For example, by moving a shutter in an increasing velocity, for example, from side A to side B of an aperture during exposure to a drilling laser beam, as described above with reference to FIG. 3, the depth of groove 98 may increase from minimal depth at side A″ to maximal depth at side B″ and/or the slope of facet 97 of groove 98 may decrease from maximal slope at side A″ to minimal slope at side B″. Facet 97 may be coated with a reflective coating, e.g., aluminum, for example, thus ensuring a total reflection of light at facet 97. Beams 92, for example, laser beams, may emerge out of a device 96, for example, a laser diode. Beams 92 may be reflected at facet 97, thus, for example, be folded and coupled into waveguide 94 with minimum loss.

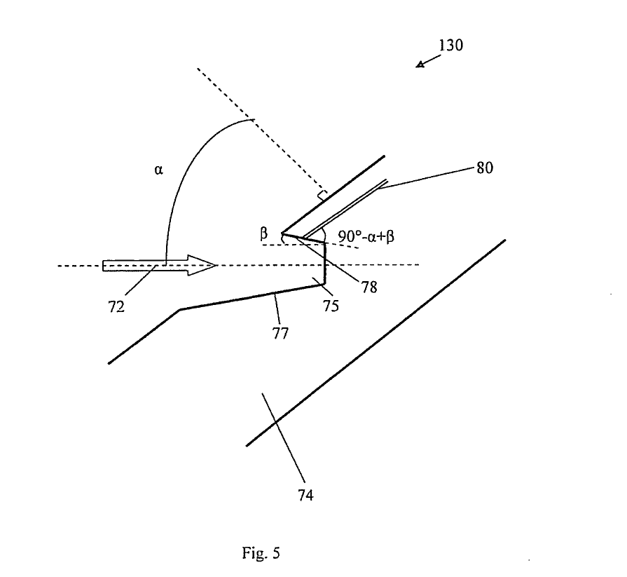

Reference is now made to FIG. 5, which is a cross section illustration of a system 130, demonstrating tuning of the direction of a drilling laser beam 72 according to inclination angle of facet 78, according to some embodiments of the present invention. Drilling laser beam 72 may produce groove 75, for example, as described above with reference to FIG. 3. Typically, the process described above creates facets 78 and 77 of groove 75 with inclination relative to the direction of drilling laser beam 72. The tuning of the direction of drilling laser beam 72 may enable setting the angle between waveguide 80 and facet 78 to a desired angle, thus, for example, beam of light advancing in waveguide 80 may meet facet 78 in a required angle in order to fold the beam of light to a desired direction. For example, setting the angle between waveguide 80 and facet 78 to an angle of 45° may enable folding of the beam of light perpendicularly to the direction of waveguide 80. Typically, waveguide 80 may be parallel to the surface of substrate 74. Facet 78 may be inclined in an angle β relative to the direction of drilling laser beam 72. For example, the direction of drilling laser beam 72 may be tuned to be in an angle of α relative to the normal to the surface of substrate 74, for example, in order to set an angle of 90°−α+β between waveguide 80 to facet 78. For illustration only, facet 78 may be inclined in an angle of 15° relative to the direction of drilling laser beam 72. For example, the direction of drilling laser beam 72 may be tuned to be in an angle of 60° relative to the normal to the surface of substrate 74, for example, in order to set an angle of 45° between waveguide 80 to facet 78.

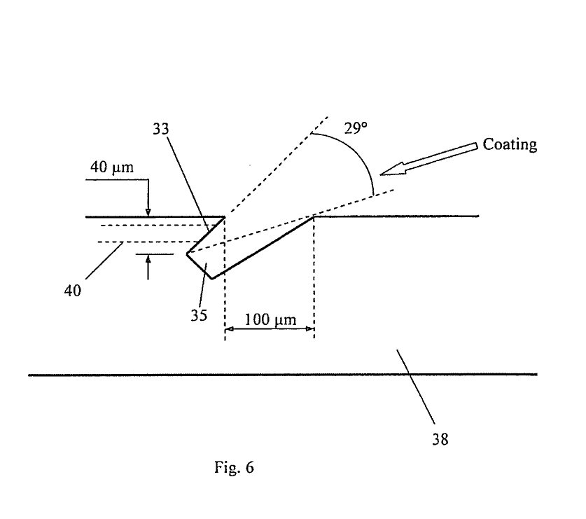

Reference is now made to FIG. 6, which is a cross section illustration of a system 140, demonstrating angle of implementation of a coating according to some embodiments of the present invention. A coating, for example, reflective coating, may be induced on facet 33, for example, in order to ensure total reflection of light at facet 33. The coating may be induced, for example, by evaporation and/or sputtering. The direction in which the coating may be induced may depend on the width of the opening of groove 35 at the surface of substrate 38 and/or on the inclination and/or depth of facet 33. For illustration only, the inclination angle of facet 33 relative to waveguide 40 may be an angle of 45°. The depth of facet 33 may be, for example, 40 μm. Thus, for example, if the width of the opening of groove 35 is, for example, 100 μm, the angle of implementation of coating on facet 33 may be an angle of 29°.

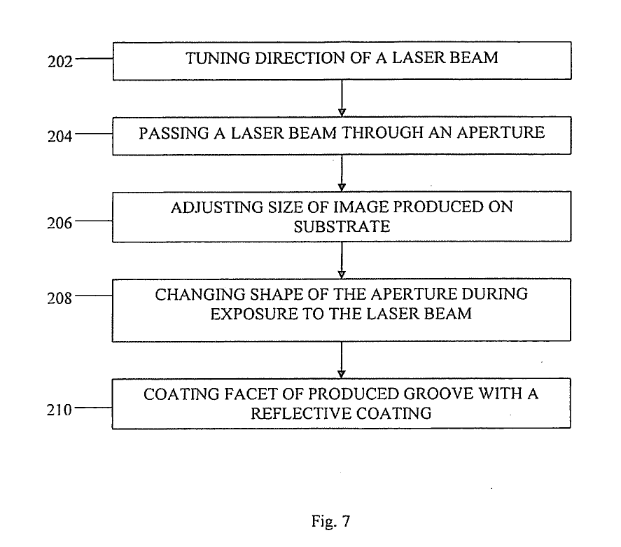

Reference is now made to FIG. 7, which is a flowchart describing a method for folding a beam of light according to some embodiments of the present invention. As indicated in block 202, the method may include tuning direction of a drilling laser beam, for example, in order to set a predetermined direction of folding of the beam of light. As indicated in block 204, the method may include passing a drilling laser beam through an aperture. Thus, for example, an image of the aperture may be produced on a substrate. As indicated in block 206, the method may include adjusting the size of the image, for example, by using lens. As indicated in block 208, the method may include changing the shape of the aperture during exposure of the aperture to the drilling laser beam, for example, in order to produce a groove with varied depth. As indicated in block 210, the method may include coating facet of the produced groove with a reflective coating, for example, in order to ensure total reflection of light at the facet of the groove.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A system for producing a groove with a required shape in a substrate, said groove having at least one facet for folding a beam of light, the system comprising:
a drilling laser beam for producing said groove, said laser beam passable through an aperture to affect the shape of said groove, wherein said at least one facet of said groove intersects a path of said beam of light.

2. A system according to claim 1, wherein said aperture is provided in a mask positioned in the path of said laser beam to said substrate.

3. A system according to claim 1, wherein said beam of light advances in a waveguide.

4. A system according to claim 1, further comprising lens for changing the size of a projection of an image of said aperture provided on said substrate by said laser beam.

5. A system according to claim 1, further comprising a shutter for changing the shape of said aperture during exposure of said substrate to said laser beam for providing varied depth to said groove.

6. A system according to claim 1, wherein at least a portion of said at least one facet is coated with a reflective coating.

7. A system according to claim 1, wherein the direction of said beam of laser is tunable for producing said groove with a predetermined angle of incidence of said beam of light with said at least one facet.

8. A method for producing a groove with a required shape in a substrate, said groove having at least one facet for folding a beam of light, the method comprising the step of:
passing a drilling laser beam through an aperture, said aperture to affect the shape of said groove; and
producing said groove, wherein said at least one facet of said groove intersects a path of said beam of light.

9. The method according to claim 8, further comprising the step of changing a projection of an image of said aperture provided on said substrate by said laser beam.

10. The method according to claim 9, wherein said changing is by using lens.

11. The method according to claim 8, further comprising the step of tuning the direction of said drilling laser beam for setting a predetermined angle of incidence of said beam of light with said at least one facet.

12. The method according to claim 8, further comprising the step of coating at least a portion of said facet with a reflective coating.

13. The method according to claim 8, further comprising the step of changing the shape of said aperture during exposure of said substrate to said laser beam for providing varied depth to said groove.

14. The method according to claim 13, wherein said changing is by moving a shutter during exposure of said substrate to said laser beam.

15. The method according to claim 13, wherein said changing is for providing said at least one facet with a concave shape.

16. The method according to claim 13, wherein said changing is for providing said at least one facet with a convex shape.
